(19) United States
(12) Patent Application Publication
(10) Pub. No.: US 2022/0411093 A1
(43) Pub. Date: Dec. 29, 2022

(54) METHOD AND DEVICE FOR ENRICHING AN OBSTACLE DATABASE FOR AIRCRAFT

(71) Applicant: THALES, Courbevoie (FR)

(72) Inventors: Thierry GANILLE, MERIGNAC (FR); Patrick CAZAUX, MERIGNAC (FR); Patrice COLZATO, MERIGNAC (FR)

(21) Appl. No.: 17/843,973

(22) Filed: Jun. 18, 2022

(30) Foreign Application Priority Data
Jun. 24, 2021 (FR) 2106767

(51) Int. Cl. B64D 43/00; G08G 5/00; G05D 1/04

(52) U.S. Cl. CPC B64D 43/00; G08G 5/006; G08G 5/003; G05D 1/042

(57) ABSTRACT

A method for enriching an obstacle database of an aircraft, the method being implemented by an on-board computer of the aircraft, and includes a creation phase performed on board the aircraft, involving a simple interaction between the pilot and a system of the cockpit, for creating an intermediate object representative of a user obstacle, the user obstacle being an obstacle identified by the pilot and not listed in the obstacle database of the aircraft, the intermediate object being created with a geographical position as its sole attribute; and a subsequent phase performed on board the aircraft, consisting in: adding type attributes characterizing the user obstacle to the intermediate object; and storing the user obstacle with the added attributes in a non-volatile memory of a module of the cockpit of the aircraft.

### CROSS-REFERENCE TO RELATED APPLICATION

This application claims priority to foreign French patent application No. FR 2106767, filed on Jun. 24, 2021, the disclosure of which is incorporated by reference in its entirety.

### FIELD OF THE INVENTION

The invention is in the technical field of aircraft flight deck display systems, and relates more particularly to the interaction of a crew with such systems.

### BACKGROUND

Annex 4 to the International Civil Aviation Organization (IACO) Convention concerning aeronautical charts defines an “obstacle” as being “All fixed (whether temporary or permanent) and mobile objects, or parts thereof, that are located on an area intended for the surface movement of aircraft; or extend above a defined surface intended to protect aircraft in flight; or stand outside those defined surfaces and that have been assessed as being a hazard to air navigation”.

Such obstacles, also designated as “significant obstacles”, are included on aeronautical charts. Each obstacle is represented on a chart as an “obstacle entity” by an appropriate conventional sign and identifier. The obstacle entities shown on a chart are linked to the attributes present in an obstacle database, such as:

the horizontal position in geographical coordinates and associated altitude;

the type of the obstacle;

the extent of the obstacle, if it occurs.

The obstacle data attributes present in an obstacle database, for example the “Digital Obstacle File” (DOF) of the “Federal Administration Aviation” (FAA), are instances of entities that may be represented by points, lines or polygons. One example of a representation of an obstacle for a mast may be a dot. One example of a representation of an obstacle for a high-voltage electricity line may be lines. One example of a representation of an obstacle for a building may be a polygon.

Such obstacles may become a threat to aircraft flying close to the ground, and particularly for helicopters when visibility is degraded, even in VFR flight conditions (VFR for “Visual Flight Rules”).

Modern cockpits are able to provide solutions for improving the situational awareness of pilots with regard to obstacles.

The prior art in terms of obstacle functions relates only to functions using obstacle data provided by an official aeronautical data provider, but without any personalization means. These functions are a 2D display on a digital chart, a 3D display on a synthetic vision system (SVS), or else an obstacle warning system that warns of obstacles for example via an impact warning and control system, or (TAWS) for “Terrain Awareness and Warning System”.

One solution provided by the company “AG-NAV” consists of an on-board GPS device called “Guia”, with a touch screen that allows navigation data and aerial spreading mission data to be displayed in the cockpit on a mobile chart. This solution uses a Web application called “AgMission” to prepare an aerial spreading mission, and which also allows an operator to insert user obstacles by clicking directly on a location on a digital chart, by entering its height, and then by saving the obstacles and by exporting them to Guia via a file. The Guia solution thus makes it possible to download user obstacle files that are created via the AgMission application. It also makes it possible to download official obstacle databases such as DOF from FAA, and then to display these obstacles on a digital chart on the touch screen in various colours, based on their height and to warn the pilot when he is flying too close to an obstacle.

However, the AgMission solution requires using a website to create new obstacles, and then a transfer via a computer file to the Guia GPS peripheral. Moreover, these obstacles are not integrated into the avionics in the sense of the systems of the certified avionics. They therefore cannot be used as obstacles in an official obstacle database to supply an SVS or even a TAWS or an HTAWS.

Mention may also be made of patents FR 3 014 233 B1 and U.S. Pat. No. 9,583,011 B2 from Airbus Helicopter, which describe aircraft systems for signalling the presence of obstacles and obstacle detection methods. These obstacle warning systems are based on the use of an unofficial on-board database that may be updated in flight (by manually adding or deleting temporary obstacles), with means for confirming the updates on the ground. New obstacles are declared only by spatial coordinates corresponding to the position of the aircraft, without any other type attribute. However, it is indicated that this approach is not subject to the constraints linked to official obstacle databases, and also no descriptive element is given with regard to performing a function that would make it possible to create “user obstacles” with implementation in the certified avionics.

Some approaches for improving an obstacle function require having an obstacle database that is precise and complete in the operating area of the aircraft. However, such a base only rarely exists, and obstacle databases are highly heterogeneous depending on the countries or depending on the areas within countries.

Even though the FAA holds a database, the DOF, which is complete and precise over the entire territory of the USA, very few countries do this, and generally only the obstacles around airports are referenced correctly in aeronautical databases.

Moreover, helicopter pilots may wish to have, in their obstacle database, new structures (antennas, wind turbines, etc.) that are not yet saved in the official databases, have temporary obstacles such as cranes or structures linked to an event, or even have individual obstacles of a group of obstacles that are saved only as a group in the official databases.

However, no solution for an avionic function or for an EFB application relating to a “user obstacle” function, which makes it possible to create an official obstacle database in flight and to enrich it directly in the cockpit, without having the abovementioned drawbacks, has been identified to date.

### SUMMARY OF THE INVENTION

The present invention addresses this need.

The invention aims to overcome the lack of obstacle data in official obstacle databases for helicopters or any other aircraft that very often fly in VFR conditions close to the ground and outside airport areas.

The present invention allows pilots to enrich obstacle databases with new obstacles themselves, directly in flight or when preparing a mission, over their area of interest.

These new obstacles, which are each designated as a “user obstacle”, become available in the avionic functions in the same way as the obstacle data provided by aeronautical database providers.

In the mission preparation phase or else directly in flight, the proposed solution allows the crew to add obstacles not listed in the database on board the aircraft, and then allows the crew to benefit from all of the functions of improving situational awareness and warning functions already present in the avionics regarding these new obstacles.

By virtue of the present invention, a user obstacle may be displayed on a 2D view of a digital mobile chart or a navigation display, on a 3D view of a main flight display SVS, or it may be supplied to a ground collision warning system (TAWS for example).

One subject of the present invention is a device that comprises means including interfaces, allowing a pilot or more generally a crew to enrich an obstacle database directly within the aircraft, on the ground and even in flight.

In general, the principle of the invention is based on the pilot creating a “temporary intermediate object” that is easy and quick to create in flight, configured so as to store the location of the new user obstacle, based on a simple action.

A simple action in the sense of the invention is an action that barely mobilizes the pilot, both in terms of his manipulation time and in terms of the mental burden involved to perform it.

A simple action may thus be for example marking the current position of the aircraft or marking a designated point from a (fixed or worn) head-up display device or marking through touch interaction on an on-board 2D map or else through designation via the line of sight of a video sensor and/or of an electro-optical system (“EOS” for example) laser.

Advantageously, the present invention works over a first phase of very short duration, allowing fast and simple designation of the position of a user obstacle (via the creation of a temporary intermediate object), followed by a second, later phase, that is to say in a calmer flight phase or after landing, for entering additional features of the created user obstacle, such as for example entering its type, its height, its width, etc.

The pilot or an operator may subsequently check and validate the data entered regarding each user obstacle and save them in the obstacle database of the aircraft as a new obstacle.

Advantageously, the device of the invention also makes it possible, after creating a first user obstacle, to directly propagate, onto multiple obstacles, features that are common thereto. This may be for example the automatic propagation of the obstacle type, or else the automatic propagation of a common obstacle height. This point is particularly beneficial for creating linear obstacles.

To achieve the desired results, what is proposed is a method for enriching an obstacle database of an aircraft, the method being implemented by an on-board computer of the aircraft, and comprising:

a creation phase performed on board the aircraft, involving a simple interaction between the pilot and a system of the cockpit, for creating an intermediate object representative of a user obstacle, the user obstacle being an obstacle identified by the pilot and not listed in the obstacle database of the aircraft, the intermediate object being created with a geographical position as its sole attribute; and

a subsequent phase performed on board the aircraft, consisting in:

adding type attributes characterizing the user obstacle to the intermediate object; and

storing the user obstacle with the added attributes in a non-volatile memory of a module of the cockpit of the aircraft.

According to some alternative or combined embodiments:

the phase of creating an intermediate object comprises a step of marking the position of the identified obstacle, through an action by the pilot at the time when the aircraft passes vertical to the identified obstacle, consisting of a simple touch interaction on a screen of the aircraft, or of a simple press of a dedicated button of the flight deck or of the control lever, the created intermediate object being symbolized at the current position of the aircraft and at the altitude of the terrain at this position;

the phase of creating an intermediate object comprises a step of marking the position of the identified obstacle, consisting in the pilot pressing a dedicated button of the flight deck or of the control lever, the button being configured so as to allow a press to trigger a marking action at the intersection of the ground with the line of sight, from the current position of the aircraft, on a screen mounted on a viewing screen worn by the pilot or a non-worn head-up screen or an electro-optical system;

the phase of creating an intermediate object comprises a step of marking the position of the identified obstacle, consisting of a touch interaction of the pilot on a navigation or mission screen of the aircraft, the screen being a human-machine interface configured so as to display a navigation chart and allow the pilot to select a location, either by designating the position of the obstacle on the chart or by entering the geographical coordinates of the obstacle in a text field, in order to trigger a marking action at the position of the obstacle;

the step of adding attributes to the intermediate object is performed via a human-machine interface configured so as to display a virtual control panel for selecting an obstacle type and entering obstacle features.

In one embodiment, the subsequent phase consists in:

selecting the intermediate object and adding type and feature attributes thereto, creating a temporary user obstacle;

selecting a location on the touch interface for creating another temporary user obstacle of the same type as the intermediate object;

repeating the location selection step in order to create other temporary user obstacles of the same type and having common features;

validating the creation of all of the temporary user obstacles in order to create as many user obstacles having the same attributes; and

storing all of the user obstacles with their attributes in a non-volatile memory of the cockpit of the aircraft, the user obstacles being new obstacles in the obstacle database of the aircraft.

In one variant embodiment, the user, in the creation phase, creates a plurality of intermediate objects for as many user obstacles with which he wishes to enrich the obstacle database of the aircraft, and the subsequent phase comprises the steps of:

selecting a first intermediate object and adding type and feature attributes thereto;

selecting one or more other intermediate objects for which he wishes to assign the same features;

validating the operations of adding attributes to all of the intermediate objects so as to create user obstacles of the same type having common features; and

storing all of the user obstacles with their attributes in a non-volatile memory of the cockpit of the aircraft, the user obstacles being new obstacles in the obstacle database of the aircraft.

In one alternative embodiment, the initial phase comprises a step of displaying a symbolic depiction of the intermediate object at said geographical position on a navigation or mission screen of the pilot, and the subsequent phase comprises a step of displaying a symbolic depiction of the user obstacle on the navigation or mission screen of the pilot.

In another alternative embodiment, the method makes it possible, after the subsequent phase, to display the one or more user obstacles on various screens of the cockpit as new obstacles in the obstacle database of the aircraft.

The invention also relates to a device comprising means for implementing the method of the invention according to the described variants.

The invention also relates to a computer program product that comprises code instructions for performing the steps of the method of the invention when the program is executed on a computer.

### BRIEF DESCRIPTION OF THE DRAWINGS

Other features and advantages of the invention will become apparent with the aid of the following description and the figures of the appended drawings, in which:

FIG. 1 illustrates one example of means for entering the position of a user obstacle in flight, according to the invention;

FIG. 2a-FIG. 2b illustrate examples of means for entering the position of a user obstacle on the ground or in flight, according to the invention;

FIG. 3a-FIG. 3c illustrate various views of an HMI according to the invention for adding features to a user obstacle;

FIG. 4a-4d illustrate, on various views of an HMI according to the invention, the propagation of features to multiple user obstacles; and

FIG. 5 is a flowchart illustrating the main steps of the user obstacle creation and common feature propagation phases, according to the invention.

### DETAILED DESCRIPTION

The principle of the invention is that of allowing, first of all (initial phase), a pilot (or a co-pilot), as soon as he identifies a new obstacle in flight, that is to say an obstacle not listed in the obstacle database of the aircraft (and therefore not symbolized on the navigation screens of the aircraft), to create a new obstacle, called “user obstacle”, with a minimum number of manipulations and very easily, and then, second of all (subsequent phase), allowing him to supplement the characterization of this user obstacle, so as to be able to list it as an obstacle in the obstacle base of the aircraft.

Advantageously, the user obstacle, when it is created, is able to be identified (that is to say symbolized) immediately on one or more navigation screens of the aircraft for the remainder of the current mission.

A new user obstacle is defined via the creation of a temporary intermediate object having the position of the user obstacle as its sole attribute.

Advantageously, the intermediate object is created in flight in a very short time, with a minimum number of operations for the pilot, corresponding to a simple action that barely mobilizes the pilot, both in terms of his manipulation time and in terms of his mental burden involved to perform it.

The creation of the intermediate object with the location corresponding to the position of the new user obstacle may take place using various means that may be adapted to the aircraft.

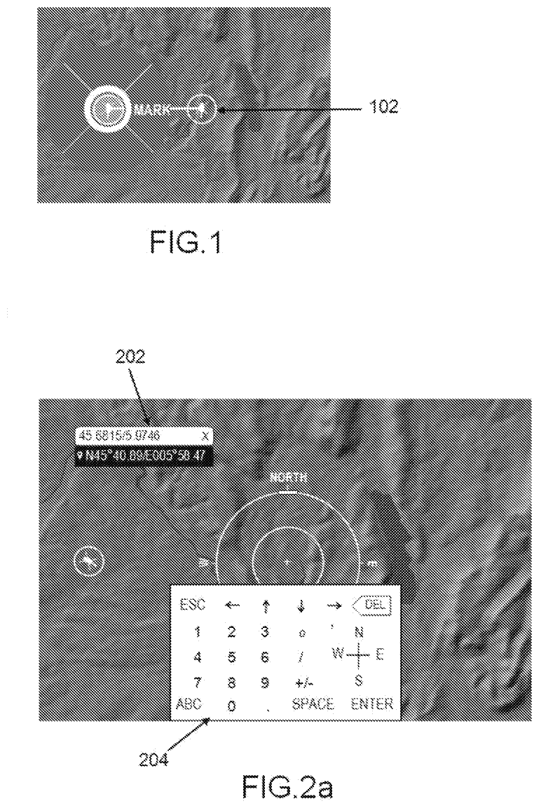

FIG. 1 illustrates one example of means for creating, in flight, in a very short time, an intermediate object with a position corresponding to a user obstacle, through a touch interaction on a navigation screen, while flying over a new obstacle that is identified by the pilot. In the example that is taken, the pilot interacts on a screen displaying a 2D digital mobile chart. As interaction, the pilot will press a symbol (102), generally called aeroplane model and depicting the aircraft, that is to say, in the illustrated example, the symbol depicts a helicopter at the current position of the aircraft on the chart. The touch interface is configured so as to display, upon a simple interaction, a contextual menu that will allow the pilot to select a marking function “MARK” through touch interaction, which then triggers the creation of an intermediate object. Thus, through simple touch interaction on a symbol on the screen at the time of flying over a new obstacle, the pilot makes it possible to trigger the creation of an intermediate object at the current position of the aircraft. The current position of the aircraft may be obtained by a geolocation system of the avionics (that is to say of the type GPS, IRS, AHRS, etc.), and its altitude on the ground may be obtained from a terrain database.

In one variant embodiment, an intermediate object representative of a user obstacle may be created using a specific button of the flight deck or of the control lever of the pilot (or co-pilot). Such a button is configured so as to allow the pilot, by pressing the button while flying over a non-listed obstacle, to trigger the creation of an intermediate object at the current position of the aircraft.

According to some variant implementations, the dedicated button may be positioned on the “cyclic stick” or on a control panel of the aircraft. Through a simple press, an intermediate object is automatically created at the current position of the aircraft, which position is obtained by a geolocation system of the avionics, and the altitude on the ground, which is obtained from a terrain database.

In another variant embodiment, an intermediate object representative of a user obstacle may be created using a screen mounted on a visualization headset worn by the pilot (“Head Mounted Display” HMD) or a head-up screen, a transparent screen fixed facing the pilot's eyes in the longitudinal axis of the aircraft (“Head Up Display” HUD) or else an orientable sensor (“Electro-Optical System” EOS).

During the flight, the pilot may call up a designation symbol, for example a cross, on the screen of the visualization headset HMD (or on the HUD or on the screen of an electro-optical system EOS). By turning his head for wearing a headset HMD (or by orienting the aircraft for the HUD or by orienting the sensor EOS), the pilot is able to superimpose the designation symbol on the real obstacle. The pilot may then press a dedicated button (for example on the “cyclic stick” or on a control panel), and an intermediate object is created automatically, at a position corresponding to the intersection of the ground (from the terrain database) with the current line of sight of the HMD (or that of the HUD or that of the EOS) from the current position of the aircraft obtained by a geolocation system of the avionics (that is to say of the type GPS, IRS, AHRS, etc.).

Those skilled in the art will understand that the described examples are not limiting in terms of their implementation, and variants may be derived so as to allow the pilot or an operator, through a simple action, that is to say a simple interaction with a component of the cockpit, to create, in the cockpit, an intermediate object having the position triggered by the interaction as its sole attribute and corresponding to the marking of a new user obstacle.

In one variant implementation of the principles of the invention, an intermediate object may be created on the ground in the cockpit, during a mission preparation phase.

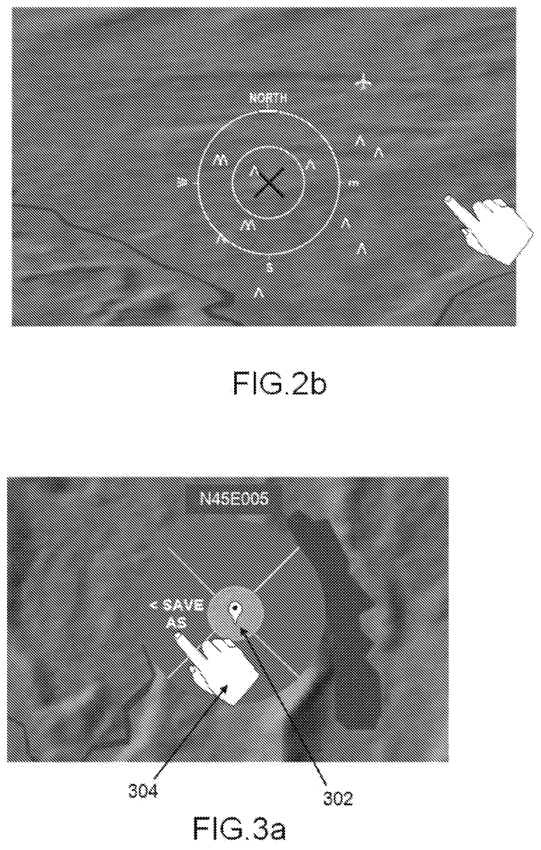

FIGS. 2a and 2b illustrate other examples of human-machine interfaces able to be configured so as to allow an operator to enter the position of a user obstacle on the ground. It should be noted that these interfaces may also make it possible, using the same principles, to enter the position of a user obstacle in flight.

FIG. 2a thus illustrates one implementation in which geographical coordinates (202) of a user obstacle may be entered in a text field via a real or virtual keypad (204). The geographical positions may be obtained by an external means (for example an online mapping service of Google Maps type or the like). An intermediate object is created at the position and at the altitude on the ground, respectively entered via the keypad for the position of the obstacle and retrieved from the terrain database for the altitude on the ground.

FIG. 2b illustrates one implementation of the principles of the invention, in which the user (the pilot for example) interacts through touch on an interactive 2D chart via a human-machine interface (HMI). The user uses a touch interaction (for example with a long press) to designate any point on the 2D mobile chart. He designates a recognizable location on a vector chart (for example a mountain, a lake, etc.) or on a digitized chart that contains obstacle information. Following the interaction, an intermediate object is created at the position and at the altitude corresponding to the interaction.

Thus, according to the principles of the invention, a pilot is able to quickly and easily create an intermediate object that is saved temporarily with a position that corresponds to the position of the user obstacle identified by the pilot and that will then be enriched with more features in a subsequent typing phase.

The action of the pilot for creating an intermediate object may be performed at the time when the aircraft passes vertical to an obstacle that is identified, and the intermediate object is created at the current position of the aircraft and at the altitude of the terrain at this position in a simple touch interaction on a navigation or mission screen of the aircraft, or in a simple press on a dedicated button of the flight deck or of the control lever.

The action of the pilot for creating an intermediate object may be performed in flight by sighting an obstacle that is identified with an HMD or an HUD or an EOS and the intermediate object is created at a position corresponding to the intersection of the ground (from the terrain database) with the current line of sight, from the position of the aircraft, of the HMD (or that of the HUD or that of the EOS) and at the altitude of the terrain at this position.

The action of the pilot for creating an intermediate object may consist of a simple touch interaction on a navigation or mission screen of the aircraft on the ground or in flight, either by designating the position of the obstacle on a mapping system or by entering the geographical coordinates of the obstacle in a text field via a real or virtual keypad. The intermediate object is created at the selected position and at the altitude of the terrain at this position.

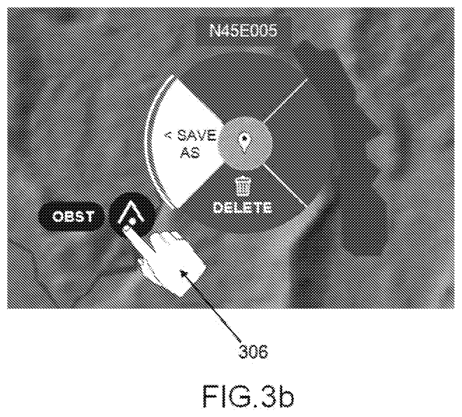

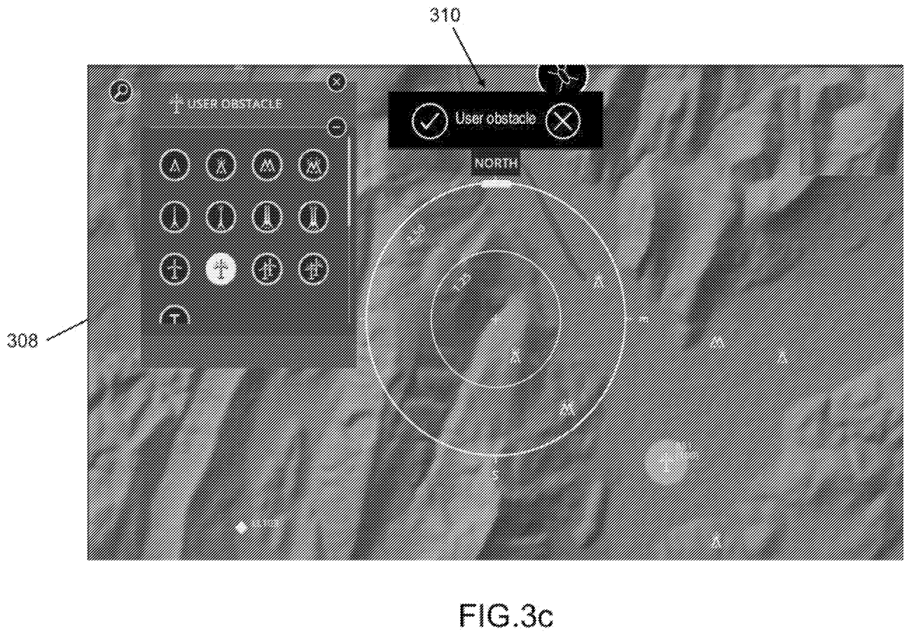

An intermediate object that is created by a pilot is displayed on the navigation or mission screen of the pilot, by a symbolic depiction for example of geolocation type, as illustrated in FIG. 3a.

The pilot may, during the initial creation phase, create as many intermediate objects as he identifies user obstacles that he wishes to declare as new obstacles, before triggering the process of characterizing the user obstacles.

FIGS. 3a to 3c illustrate various views of an HMI for implementing the invention, allowing an operator to add attributes to an intermediate object. Advantageously, and in a manner different from the solutions from the prior art, this subsequent manipulation phase is also performed on board the aircraft, either in flight during a quieter flight phase or on the ground after a flight or on the ground before a flight in order to finalize the preparation of a mission if the intermediate objects have been created on the ground.

In FIG. 3a, after the operator (in principle the pilot) has selected an intermediate object (302) on the touch screen, a contextual menu is displayed so as to offer him an option to save “SAVE AS”. The contextual menu may offer other functions, such as an option to delete “DELETE”.

To create a user obstacle from the intermediate object, the user selects the save function (304).

The user may alternatively delete the selected symbol (302) if the created intermediate object is incorrectly positioned, and he may create a new one at the correct position.

FIG. 3b illustrates a following view of the HMI when the user has selected the save function. The contextual menu offers a function for saving the intermediate object as an obstacle “OBST” by selecting the obstacle function (306).

By selecting the save as an obstacle function (for example through a simple touch), a user obstacle (“User Obstacle”) virtual control panel opens, as illustrated in FIG. 3c.

The user obstacle virtual control panel (308) offers the pilot various fields allowing him to select the obstacle type (for example a wind turbine) and to enter features relating to this obstacle.

He may thus for example enter the latitude and the longitude more precisely, or enter the height, the elevation and the width of the obstacle.

According to some embodiments, and for the specific needs of an application, the interface of the user obstacle virtual control panel may be configured for the entry of other additional information, such as for example indicating whether or not the obstacle is lit, whether or not the obstacle is temporary, indicating how many objects this obstacle is associated with (“number”), etc.

Those skilled in the art will understand that the fields that are indicated are indicated only by way of non-limiting example, and that any other field for describing features of the obstacle may be considered, upwards or downwards.

Once all of the features have been entered, the user may save them (310) and a new user obstacle is created. The user obstacle is then saved in a non-volatile memory of a module of the cockpit. At the end of this method, the user obstacle is displayed by a symbolic depiction of the obstacle type (and no longer as an intermediate object) on the navigation or mission screen of the pilot.

The user obstacle creation method as described may be associated with additional steps allowing the user obstacle saved in a volatile memory to be taken into account as a new obstacle in the obstacle database of the aircraft. The user obstacle may then be displayed on various screens of the cockpit and may be taken into account as an obstacle in the obstacle database of the aircraft by the various functional modules of the aircraft, such as the TAWS for example.

Another advantage of the device of the invention is that of offering a mechanism that makes it possible to propagate the features entered for a first user obstacle to other user obstacles in one go. This functionality is particularly beneficial when creating multiple obstacles of the same kind. One typical example is that of a field of wind turbines, in which it is then necessary to enter the features only for a first wind turbine, and then to be able to distribute said features to all of the other wind turbines without having to enter them for each one.

Other examples of obstacles that benefit from the advantage of propagating common features of a user obstacle to a plurality of other user obstacles are linear obstacles such as electricity lines or telephone lines with similar masts.

The feature propagation method may be implemented according to various alternatives.

In a first alternative, the user, in the creation phase, creates a plurality ‘n’ of intermediate objects for as many user obstacles with which he wishes to enrich the obstacle database of the aircraft.

In the subsequent phase, he selects a first intermediate object, he designates it as a user obstacle (“Save As” OBST, FIGS. 3a and 3b), and then he enters its type and its features (FIG. 3c).

He then selects, on the screen, another intermediate object for which he wishes to assign the same features.

The method allows the features entered for the first intermediate object to be automatically assigned to this other non-listed intermediate object that is selected. This operation may be repeated, and this makes it possible to create as many user obstacles of the same type having common features.

Once all of the user obstacles have been created, the method makes it possible to store all of the user obstacles with their attributes in a non-volatile memory of the cockpit of the aircraft. The stored user obstacles may become new obstacles in the obstacle database of the aircraft.

In a second alternative, the user does not need to create as many intermediate objects as user obstacles having the same features in the initial phase.

Indeed, he may create a single intermediate object in the initial phase, and create multiple user obstacles from this intermediate object in the subsequent phase.

Thus, in the subsequent phase, he selects the intermediate object and enters its type and its features without finalizing the validation (that is to say FIGS. 3a to 3c up to before the last save step 310). The entered intermediate object may be seen as a temporary user obstacle.

Next, he selects (on the screen) a location (or he enters the geographical coordinates of a location) where he wishes to create another user obstacle of the same type as the previous one in order to create a new temporary user obstacle of the same type and having common features. He may repeat the location selection steps in order to create other temporary user obstacles of the same type and having common features.

Upon each selection of a location, a new temporary user obstacle of the same type and having common features is directly created.

Once all of the temporary user obstacles have been created, the pilot may validate all of the temporary user obstacle creation operations. All of the temporary user obstacles are validated as new user obstacles of the same type and having common features.

The method makes it possible to save the user obstacles with their attributes and to store them in a non-volatile memory of a module of the cockpit.

The stored user obstacles may become new obstacles in the obstacle database of the aircraft.

Advantageously, this alternative makes it possible not to create a new intermediate object for each user obstacle since all of the common features to be applied to the new obstacles are already entered for the first temporary user obstacle.

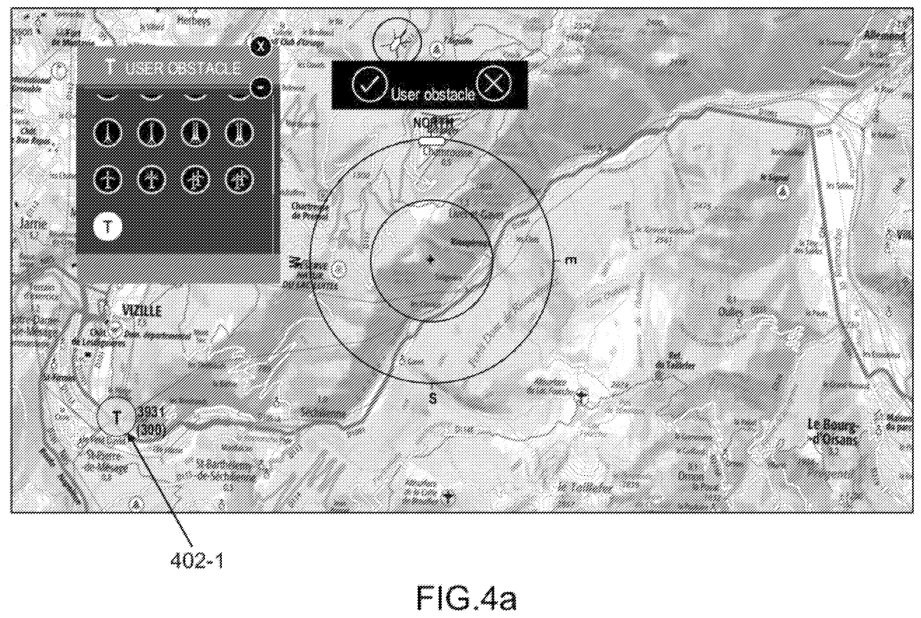

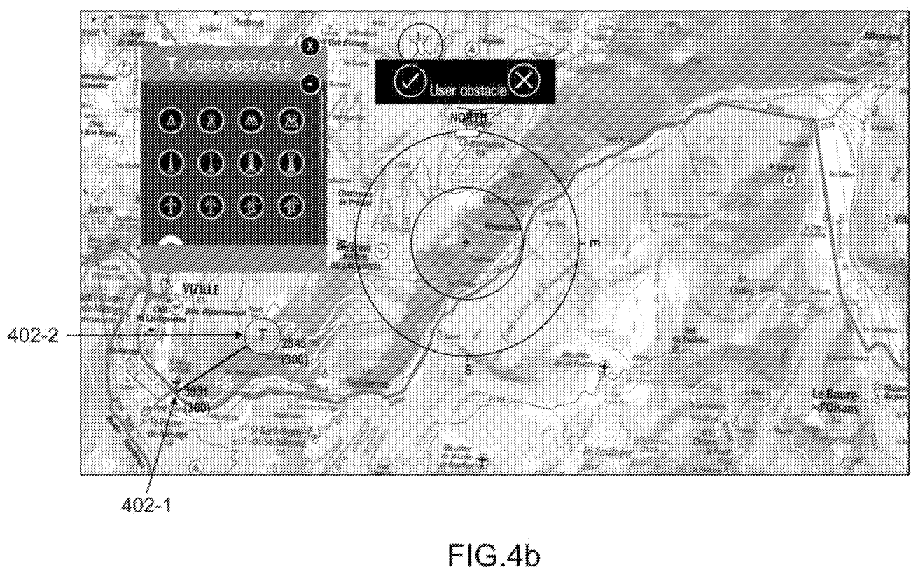

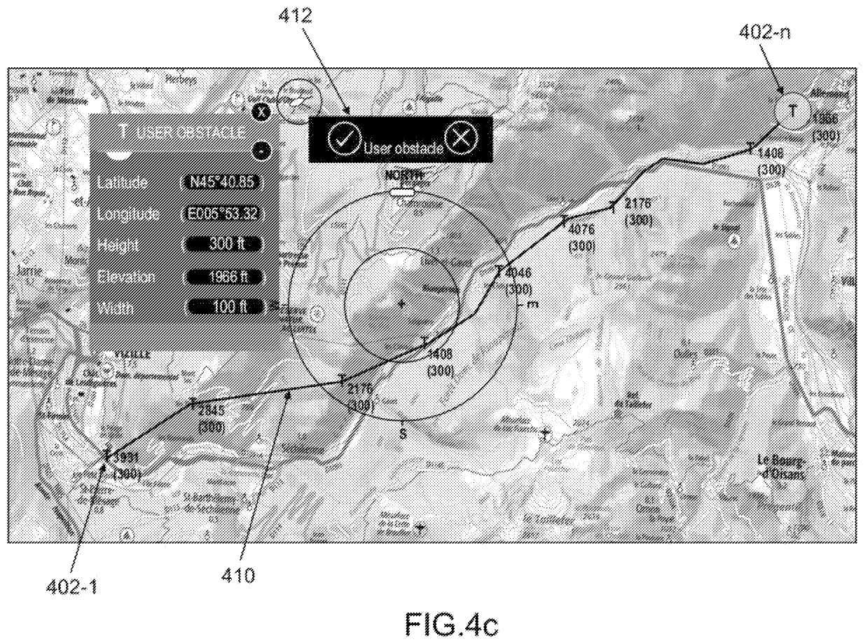

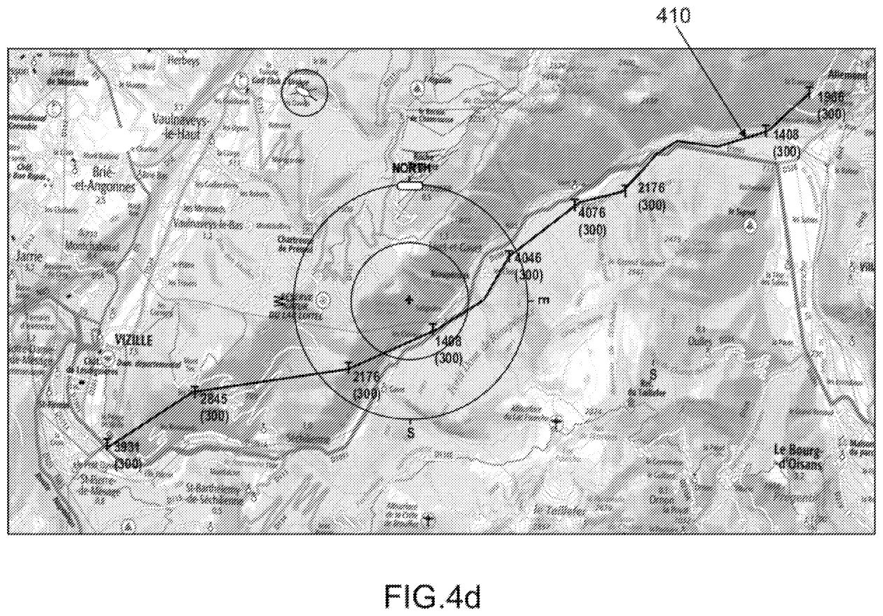

FIGS. 4a to 4d illustrate, in various views of an HMI configured so as to implement the principles of the invention, the operations of propagating common features of a first user obstacle to a plurality of other user obstacles.

FIG. 4a shows a first user obstacle (402-1) of linear obstacle type, that is to say symbolized by the letter ‘T’, which is positioned on a digitized 2D chart, at the location where the intermediate object was created. In the example chosen, the user obstacle was created on the chart (via the intermediate object) at the location of a change of direction of a high-voltage line.

In FIG. 4b, a second location (402-2) is selected on the chart, so as to define a second user obstacle there. The second location is temporarily connected to the first by a line that remains displayed in a first colour for as long as all of the new user obstacles are not validated.

The pilot proceeds in the same way for as many locations as he wants. FIG. 4c illustrates the creation of a plurality of user obstacles connected by a line. For each selection of a location, the user may possibly enter information specific to the corresponding obstacle. After selecting the last location (402-n), the user validates (412) the selection in order to create a group of user obstacles (402-1 to 402-n) of the same type having common features.

As illustrated in FIG. 4d, in the case of linear obstacles, the interface is configured so as to make it possible to display, on the 2D chart, a line (410) connecting all of the user obstacles belonging to the same group to one another, the line possibly being displayed in a standardized colour for obstacles of this type.

By validating the selection of a group of user obstacles, the group is saved in a non-volatile memory of a component of the cockpit to allow it to be used as obstacles in the obstacle database of the aircraft in subsequent missions.

In one operating mode, the user may create a series of user obstacles of the same type but not necessarily having the same features. He may save all of the created obstacles in one go (412).

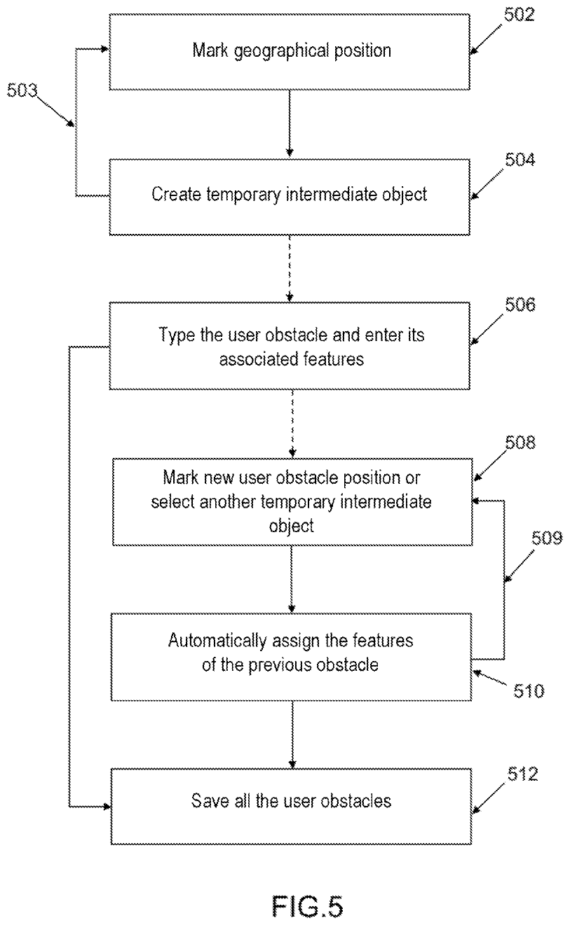

FIG. 5 is a flowchart of the main steps of the user obstacle creation and common feature propagation phases, according to the invention.

The user obstacle creation method is performed on board the aircraft, and consists, in a first phase, in marking the geographical position of a user obstacle (502), the marking possibly being performed using one of the means described above, in order to create a temporary intermediate object (504) whose position is associated with the identified user obstacle.

The user, during a mission, may repeat (503) this step of marking the position of user obstacles.

In a subsequent phase (which may take place immediately after the first phase or be deferred), the method consists in typing the one or more intermediate objects and in adding features (506) in order to describe each user obstacle in more detail. The additional features may for example be entered using the approach described with reference to FIGS. 3a to 3c.

Once a user obstacle has been created with its features, the user may save it (512) in a non-volatile memory of a module of the cockpit.

Optional steps of the method of the invention make it possible to propagate features entered during the creation of a first user obstacle to one (508, 510) or to multiple (509, 508, 510) other obstacles, using the alternative approaches described above (marking the position of a new user obstacle or selecting another temporary intermediate object).

The method makes it possible to save (512) all of the new user obstacles that have been created during one and the same subsequent phase in one go, along with those created by propagating common features according to the described alternatives.

The created user obstacles are saved in a non-volatile memory of the cockpit in order to be able to be used as new obstacles in the obstacle database of the aircraft in a subsequent mission.

1. A method for enriching an obstacle database of an aircraft, the method being implemented by an on-board computer of the aircraft, and comprising:
a creation phase performed on board the aircraft, involving a simple interaction between the pilot and a system of the cockpit, for creating an intermediate object representative of a user obstacle, the user obstacle being an obstacle identified by the pilot and not listed in the obstacle database of the aircraft, the intermediate object being created with a geographical position as its sole attribute; and
a subsequent phase performed on board the aircraft, consisting in:
adding type attributes characterizing the user obstacle to the intermediate object; and
storing the user obstacle with the added attributes in a non-volatile memory of a module of the cockpit of the aircraft.

2. The method according to claim 1, wherein the phase of creating an intermediate object comprises a step of marking the position of the identified obstacle, through an action by the pilot at the time when the aircraft passes vertical to the identified obstacle, consisting of a simple touch interaction on a screen of the aircraft, or of a simple press of a dedicated button of the flight deck or of the control lever, the created intermediate object being symbolized at the current position of the aircraft and at the altitude of the terrain at this position.

3. The method according to claim 1, wherein the phase of creating an intermediate object comprises a step of marking the position of the identified obstacle, consisting in the pilot pressing a dedicated button of the flight deck or of the control lever, the button being configured so as to allow a press to trigger a marking action at the intersection of the ground with the line of sight, from the current position of the aircraft, on a screen mounted on a viewing screen worn by the pilot or a non-worn head-up screen or an electro-optical system.

4. The method according to claim 1, wherein the phase of creating an intermediate object comprises a step of marking the position of the identified obstacle, consisting of a touch interaction of the pilot on a navigation or mission screen of the aircraft, the screen being a human-machine interface configured so as to display a navigation chart and allow the pilot to select a location, either by designating the position of the obstacle on the chart or by entering the geographical coordinates of the obstacle in a text field, in order to trigger a marking action at the position of the obstacle.

5. The method according to claim 1, wherein the step of adding attributes to the intermediate object is performed via a human-machine interface configured so as to display a virtual control panel for selecting an obstacle type and entering obstacle features.

6. The method according to claim 1, wherein the subsequent phase consists in:
selecting the intermediate object and adding type and feature attributes thereto, creating a temporary user obstacle;
selecting a location on the touch interface for creating another temporary user obstacle of the same type as the intermediate object;
repeating the location selection step in order to create other temporary user obstacles of the same type and having common features;
validating the creation of all of the temporary user obstacles in order to create as many user obstacles having the same attributes; and
storing all of the user obstacles with their attributes in a non-volatile memory of the cockpit of the aircraft, the user obstacles being new obstacles in the obstacle database of the aircraft.

7. The method according to claim 1, wherein the user, in the creation phase, creates a plurality of intermediate objects for as many user obstacles with which he wishes to enrich the obstacle database of the aircraft; and wherein the subsequent phase comprises the steps of:
selecting a first intermediate object and adding type and feature attributes thereto;
selecting one or more other intermediate objects for which he wishes to assign the same features;
validating the operations of adding attributes to all of the intermediate objects so as to create user obstacles of the same type having common features; and
storing all of the user obstacles with their attributes in a non-volatile memory of the cockpit of the aircraft, the user obstacles being new obstacles in the obstacle database of the aircraft.

8. The method according to claim 1, wherein the creation phase comprises a step of displaying a symbolic depiction of the intermediate object at said geographical position on a navigation or mission screen of the pilot, and the subsequent phase comprises a step of displaying a symbolic depiction of the user obstacle on the navigation or mission screen of the pilot.

9. The method according to claim 1, making it possible, after the subsequent phase, to display the one or more user obstacles on various screens of the cockpit as new obstacles in the obstacle database of the aircraft.

10. A computer program product, said computer program comprising code instructions for performing the steps of the method according to claim 1 when said program is executed on a computer.

11. A device for enriching an obstacle database of an aircraft, the device comprising means for implementing the steps of the method according to claim 1.
